(19) United States
(12) Patent Application Publication
(10) Pub. No.: US 2024/0286556 A1
(43) Pub. Date: Aug. 29, 2024

(54) ROOF RAIL ASSEMBLY AND ROOF RAILS

(71) Applicant: GUANGZHOU ISSYZONE TECHNOLOGY CO.,LIMITED, Guangzhou (CN)

(72) Inventors: TAIPING YANG, Shenzhen (CN); GUANWEN CHEN, Zhaoqing (CN); GUOCHAO XU, Guangzhou (CN)

(21) Appl. No.: 18/201,805

(22) Filed: May 25, 2023

(30) Foreign Application Priority Data
Feb. 24, 2023 (CN) 202320311558.6

(51) Int. Cl. B60R 9/04

(52) U.S. Cl. CPC B60R 9/04

(57) ABSTRACT

The present application discloses a roof rail assembly and a roof rail, wherein the roof rail assembly comprises a rail body made of hard rubber-plastic foam, and a through hole penetrating along a length direction of the rail body is provided on a side of the rail body, and the through hole is configured to accommodate a first webbing.

### CROSS-REFERENCE TO RELATED APPLICATIONS

This application claims the benefit and priority of Chinese patent application No. 202320311558.6, filed on Feb. 24, 2023, disclosure of which is hereby incorporated by reference in its entirety.

### TECHNICAL FIELD

The present application relates to the technical field of auto parts, in particular to a roof rail assembly and a roof rail.

### BACKGROUND

SUV refers to a sports multi-purpose vehicle. The two sides of the roof are generally equipped with two longitudinal bars, also known as luggage racks, which are used to secure the subsequently installed roof rails through which the luggage compartment is then mounted. During non-traveling, most car owners will choose to remove the roof rails. One is because the roof rail will increase the overall wind resistance of the vehicle, resulting in higher fuel consumption, and the other is because the design of the roof rail is not beautiful. For the above reasons, the roof rail is required to be detachable at the beginning of the design.

Most of the detachable designs of existing roof rails use clamping solutions. For example, CN105292001A discloses a roof rail. The two ends of the roof rail use typical clamping parts, which are mainly fixed by bolts. If the bolts are not fixed firmly, the clamping parts will slip with the luggage rack which can easily lead to scratching the luggage rack.

### SUMMARY

In view of the above problems, the present application proposes a roof rail assembly and a roof rail, which mainly solves the problem that the clamped roof rail is easy to scratch the luggage rack.

In order to solve the above technical problems, the first aspect of the present application proposes a roof rail assembly, which comprises a rail body made of hard rubber-plastic foam, and a through hole penetrating along a length direction of the rail body is provided on a side of the rail body, and the through hole is configured to accommodate a first webbing.

In some embodiments, the hard rubber-plastic foam is EVA material.

In some embodiments, a bottom of the rail body is planar, and the bottom of the rail body is provided with first anti-skid pattern.

In some embodiments, at least one first groove is provided on the bottom of the rail body, and the first groove communicates with the through hole.

In some embodiments, top of the rail body is provided with at least two fasteners along its length direction, and the fasteners are configured to fix a second webbing.

In some embodiments, the top of the rail body is provided with at least one engaging groove, and the engaging groove is located between the two fasteners.

In some embodiments, the top of the rail body is provided with a second groove, and the fasteners are arranged in the second groove.

In some embodiments, the fastener comprises a fastener body, a first stopper fixed at a lower end of the fastener body, and a second stopper matching the first stopper, a first mounting hole for accommodating the first stopper is provided at a lower end of the second groove, and a second mounting hole for accommodating the second stopper is provided at an upper end of the through hole, the first mounting hole and the second mounting hole communicate in the same vertical direction, the first stopper and the second stopper move toward each other along the first mounting hole and the second mounting hole respectively until the first stopper and the second stopper are locked to each other.

In some embodiments, the top of the rail body is planar, and the top of the rail body is provided with a second anti-skid pattern.

The second aspect of the present application proposes a roof rail, which comprises at least roof rail assemblies, and any two of the roof rail assemblies are sequentially combined along their lengths, the first webbing passes through the through holes of the two roof rail assemblies in sequence, and a first and last ends of the first webbing are fixed in a first fastener.

The beneficial effect of the present application is that: the rail body is made of hard rubber-plastic foam, and the good cushioning properties of the hard rubber-plastic foam can prevent the luggage rack from being scratched.

### BRIEF DESCRIPTION OF DRAWINGS

FIG. 1 is a structural schematic diagram of a roof rail assembly disclosed in the first embodiment of the present application;

FIG. 2 is a structural schematic diagram of the roof rail assembly disclosed in the first embodiment of the present application at another perspective;

FIG. 3 is a cross-sectional diagram of the roof rail assembly disclosed in the first embodiment of the present application;

FIG. 4 is a structural schematic diagram of a roof rail disclosed in the second embodiment of the present application;

Reference signs: 1-Rail body, 2-Through hole, 3-First anti-skid pattern, 4-First groove, 5-Fastener, 501-Fastener body, 502-First stopper, 503-Second stopper, 504-First mounting hole, 505-Second mounting hole, 506-, 6-Second anti-skid pattern, 7-Engaging groove, 8-Second groove, 9-First webbing, 10-First buckle, 11-Second webbing, 12-Second buckle, 100-Roof rail assembly.

### DETAILED DESCRIPTION

The technical solution in the embodiment of the present application will be clearly and completely described below in conjunction with the accompanying drawings in the embodiment of the present application. Apparently, the described embodiments are only some of the embodiments of the present application, rather than all the embodiments. Based on the embodiments in the present application, all other embodiments obtained by a person skilled in the art without making creative efforts belong to the protection scope of the present application.

It should be noted that the terms “first” and “second” in the description and claims of the present application and the above drawings are used to distinguish similar objects, but not necessarily used to describe a specific sequence. It is to be understood that the data so used are interchangeable under appropriate circumstances such that the embodiments of the present application described herein can be practiced in sequences other than those illustrated or described herein. In addition, the terms “comprising” and “including” in the embodiments of the present application and any variations thereof are intended to cover non-exclusive inclusion. For example, a process, method, system, product, or device comprising a series of steps or units is not necessarily limited to those steps or units explicitly listed, but may include steps or units not explicitly listed or for these processes, methods, products, or other steps or units inherent to equipment.

It is to be understood that the orientation or positional relationship indicated by the terms “center”, “longitudinal”, “transverse”, “length”, “width”, “thickness”, “top”, “bottom”, “front”, “rear”, “left”, “right”, “vertical”, “horizontal”, “inner”, “outer”, “Clockwise”, “counterclockwise”, “axial”, “radial” etc. are based on the orientation or positional relationship shown in the drawings, and are only for the convenience of describing the application and simplifying the description, rather than indicating or implying that the device or element referred to must have a particular orientation, be constructed and operate in a particular orientation, and thus should not be construed as limiting the present application.

In the description of the present application, “plurality” means at least two, such as two, three, etc., unless otherwise specifically defined. In addition, the terms “arranged”, “connected” and “connecting” are to be interpreted broadly unless otherwise expressly specified and limited. For example, it can be a fixed connection, a detachable connection, or an integral connection; it can be a mechanical connection or an electrical connection; it can be directly connected, or indirectly connected through an intermediary, and can be internally connected between two elements. Those of ordinary skill in the art can understand the specific meanings of the above terms in this application in specific situations.

In the present application, unless otherwise clearly specified and limited, a first feature being “on” or “under” a second feature may mean that the first and second features are in direct contact, or that the first and second features are indirect contact through an intermediary. Moreover, the first feature “on” or “above” the second feature may mean that the first feature is directly above or obliquely above the second feature, or simply means that the level of the first feature is higher than the second feature. The first feature “below” or “beneath” the second feature may mean that the first feature is directly below or obliquely below the second feature, or simply means that the level of the first feature is less than the second feature.

### The First Embodiment

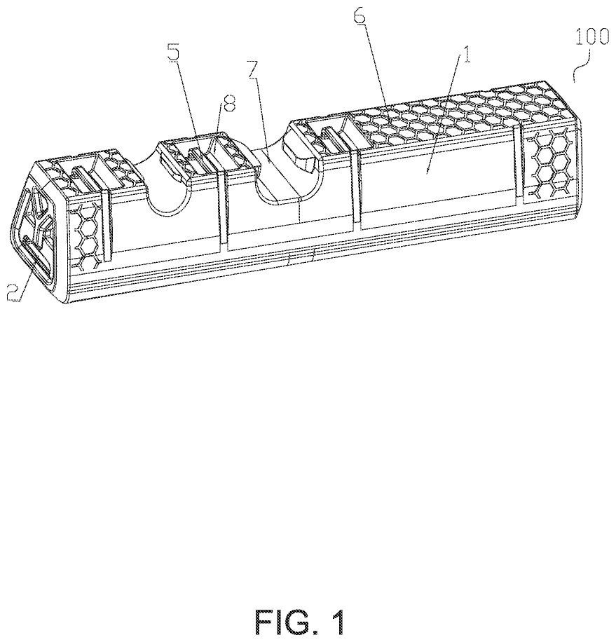

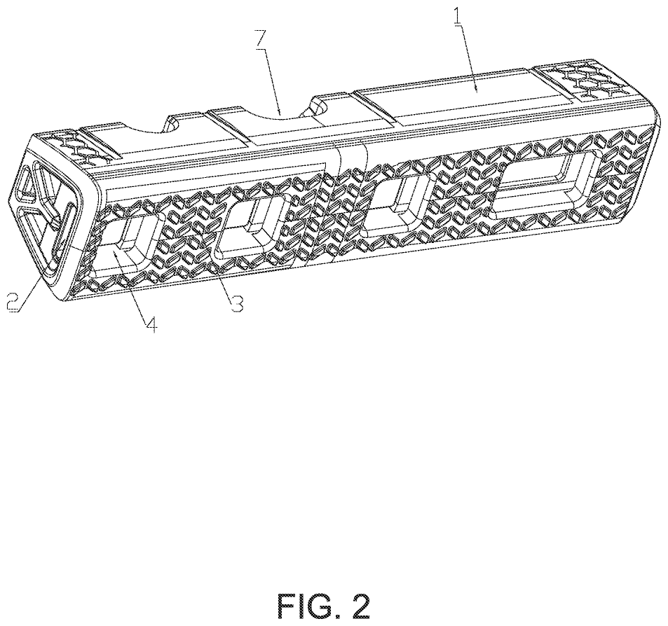

This embodiment proposes a roof rail assembly 100, as shown in FIGS. 1 and 2, comprising a rail body 1 made of hard rubber-plastic foam, and a through hole 2 penetrating along a length direction of the rail body is provided on a side of the rail body 1, and the through hole 2 is configured to accommodate a first webbing. In this embodiment, the first webbing can be any narrow fabric or tubular fabric. When the first webbing passes through the through hole 2, it forms a fixed relationship with the rail body 1. Then the two ends of the first webbing go around the luggage rack, and finally the two ends of the first webbing are fixed in a buckle, that is, the binding between the rail body 1 and the luggage rack is realized. Due to the soft nature of the first webbing itself, the luggage rack will not be scratched. This embodiment mainly discloses the specific structure of the rail body 1, and for the specific installation method of the first webbing, please refer to the second embodiment.

In the present embodiment, the rail body 1 is made of bard rubber-plastic foam, and the good cushioning properties of the hard rubber-plastic foam can prevent the luggage rack from being scratched.

The above-mentioned hard rubber-plastic foam can be any hard foam plastic, preferably EVA material, its good cushioning properties can prevent the luggage rack from being scratched, and it has a certain rigidity, and is easy to manufacture and low in manufacturing cost.

In an optional embodiment, as shown in FIG. 2, a bottom of the rail body 1 is planar, and the bottom of the rail body 1 is provided with first anti-skid pattern 3. In this solution, the bottom of the rail body 1 is processed into a plane, so the rail body 1 can be placed directly on the roof of the car without putting the two ends of the rail body 1 on the upper end of the luggage rack. Furthermore, the design of the first anti-skid pattern 3 can prevent the rail body 1 from slipping on the roof during driving.

In order to prevent the first webbing from being unable to pass through the through hole 2 smoothly, in yet another optional embodiment, continue to refer to FIG. 2, at least one first groove 4 is provided at the bottom of the rail body 1, and the first groove 4 communicates with the through hole 2. If there are a plurality of the first grooves 4, the first grooves 4 should be arranged along the length direction of the through hole 2. In this solution, the user can insert a finger into the through hole 2 from the first groove 4, and adjust the first webbing stuck in the through hole 2 until the first webbing passes through the other end of the through hole 2 smoothly.

In yet another optional embodiment, referring to FIG. 1, at least two fasteners 5 are provided on the top of the rail body 1 along its length direction, and the fasteners are configured to fix the second webbing. In this solution, the top of the rail body 1 is used as a contact surface for luggage, and there is no need to install luggage racks additionally. When there is a need to fix the luggage directly on the top of the rail body 1, only one end of the second webbing needs to pass through the two fasteners 5 in sequence. The second webbing forms a length-adjustable belt between the two fasteners 5, and the luggage is placed between the two fasteners 5, and finally the second webbing will be tightened, that is, the binding between the rail body 1 and the luggage will be realized. Due to the softness of the second webbing itself, the luggage will not be scratched. This embodiment mainly discloses the specific structure of the rail body 1, and for the specific installation method of the second webbing, please refer to the second embodiment.

More preferably, in order to enhance the fixing effect between the luggage and the rail body 1, continue to refer to FIG. 1, the top of the rail body 1 is planar, and the top of the rail body 1 is provided with a second anti-skid pattern 6. The contact area between the luggage and the rail body 1 can be enlarged by processing the top of the cross-bar body 1 into a plane. The design of the second anti-skid pattern 6 can prevent luggage from slipping on the top of the rail body 1 during driving.

It should be noted that the width of the rail body 1 is limited. When the area occupied by the luggage is large, one rail body 1 is not enough to fix the luggage firmly. Therefore, it is necessary to use two or more rail bodies 1 spaced apart along the length direction of the luggage rack. The lower end of the luggage is placed between several rail bodies 1, and continue to use the above-mentioned fixing method, and use several second webbings to jointly fix the luggage.

In yet another optional embodiment, referring to FIGS. 1 and 2, the top of the rail body 1 is provided with at least one engaging groove 7, and the engaging groove 7 is located between two fasteners 5. The cross-section of the engaging groove 7 can be a long groove with a single opening of any shape, in which a slender object, such as a fishing rod, can be embedded, and further fixed by two fasteners 5 and the second webbing. Similarly, when the length of the slender object is too large, one rail body 1 is not enough to firmly fix the slender object, and two rail bodies 1 spaced apart along the length direction of the luggage rack need to be used, and the slender object, the two ends of the slender object ride between the two grooves 7.

In order to prevent the height of the fastener 5 from being higher than the upper plane of the rail body 1, continue to refer to FIG. 1, the top of the rail body 1 is provided with a second groove 8, and the fastener 5 is arranged in the second groove 8. In this way, the fastener 5 can be prevented from being crushed and damaged by luggage, and the upper end surface of the rail body 1 has no protrusions, so that the contact area between the luggage and the rail body 1 is the largest.

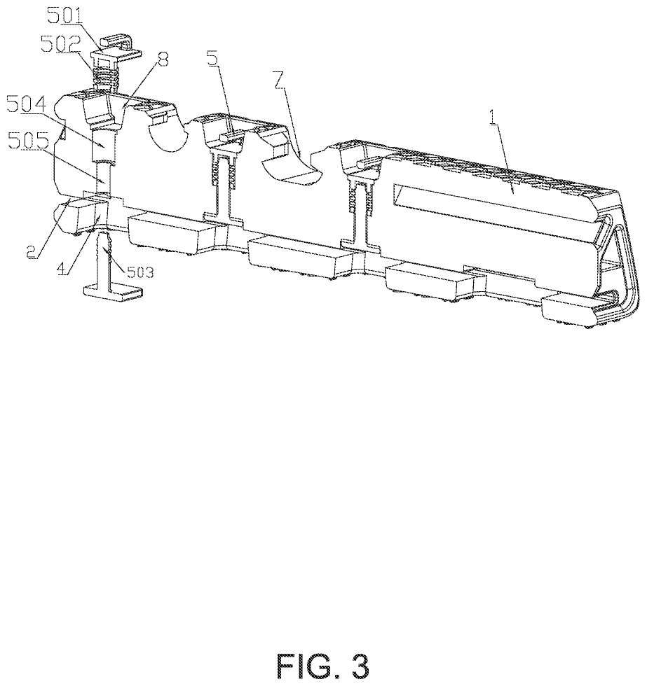

The above-mentioned fastener 5 can be any anti-slip fastener that can be matched with the webbing and can be adjusted in length. For example, the typical tri-glide fastener, or a fastener that changes based on the typical tri-glide fastener. In one example, as shown in FIG. 3, the fastener 5 comprises a fastener body 501, a first stopper 502 fixed at a lower end of the fastener body 501, and a second stopper 503 matching the first stopper 502, a first mounting hole 504 for accommodating the first stopper 502 is provided at a lower end of the second groove, and a second mounting hole 505 for accommodating the second stopper 503 is provided at an upper end of the through hole 2, the first mounting hole 504 and the second mounting hole 505 communicate in the same vertical direction, the first stopper 502 and the second stopper 503 move toward each other along the first mounting hole 504 and the second mounting hole 505 respectively until the first stopper 502 and the second stopper 503 are locked to each other.

In FIG. 3, the above-mentioned first stopper 502 is a cylinder with upwardly inclined saw tooth inside, and the second stopper 503 is an elastic member with an inverted T-shaped cross section. The upper end of the elastic member is a column, and the outer side of the column is provided with upwardly inclined saw tooth. When the two sets of saw teeth engage, the first stopper 502 is locked in the first mounting hole 504, so that it appears that the fastener 5 is fixed in the second groove 8. In this solution, the fastener body 501 and the first stopper 502 are integrated, that is, the fastener 5. Both the fastener 5 and the second stopper 503 are parts other than the rail body 1, which can reduce the difficulty of foaming and reverse molding the rail body 1. Before the product is used, the fastener 5 and the second stopper 503 can be installed by the user, which reduces the labor cost of the manufacturer.

### The Second Embodiment

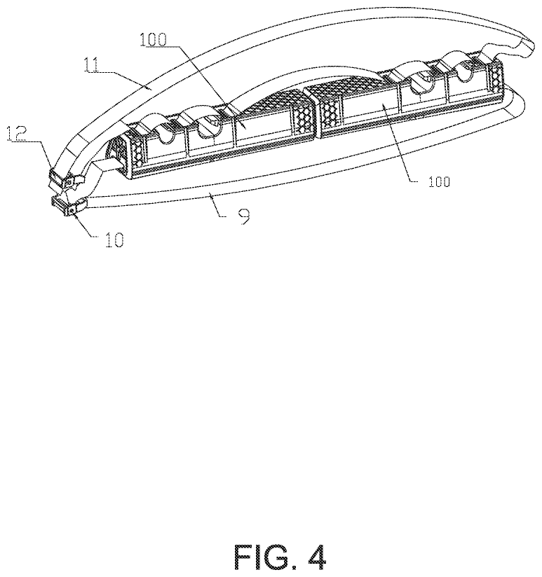

This embodiment proposes a roof rail, as shown in FIG. 4, comprising at least two roof rail assemblies 100 described in the first Embodiment, and any two roof rail assemblies 100 are sequentially combined along their own lengths. The number of roof rail assemblies 100 can be selected according to the actual vehicle width. The first webbing 9 passes through the through holes 2 of the two roof rail assemblies 100 in sequence, and the first and last ends of the first webbing 9 are fixed in the first buckle 10.

One end of the second webbing 11 passes through the plurality of fasteners 5 sequentially, and both ends of the second webbing 11 are fixed in the second buckle 12.

Apparently, no matter the number of assembled roof rail assemblies 100 is two or more, only one first webbing 9 and one second webbing 11 are needed, aiming to use as few buckles as possible, to ensure a fixed effect.

In this embodiment, the roof rail is composed of at least two roof rail assemblies 100, and its assembly and disassembly are fast and simple. Only by loosening the first buckle 10 and the second buckle 12, the roof rail assembly 100 and the luggage can be disassembled. Moreover, the modular design of the roof rail assembly 100 enables it to be adapted to any vehicle model, and is easy to store and does not take up space after storage.

In the description of this specification, descriptions referring to the terms “one embodiment”, “some embodiments”, “example”, “specific examples”, or “some examples” mean that specific features, structure, material or characteristic described in connection with the embodiment or example are included in at least one embodiment or example of the present application. In this specification, the schematic representations of the above terms are not necessarily directed to the same embodiment or example. Furthermore, the described specific features, structures, materials or characteristics may be combined in any suitable manner in any one or more embodiments or examples. In addition, those skilled in the art can combine different embodiments or examples and features of different embodiments or examples described in this specification without conflicting with each other.

The above-mentioned embodiments are just to illustrate the technical concept and features of the present application, and the purpose is to enable those of ordinary skill in the art to understand the content of the present application and implement it accordingly, and not to limit the protection scope of the present application. All equivalent changes or modifications made according to the essence of the content of the application shall fall within the protection scope of the present application.

What is claimed is:

1. A roof rail assembly, comprising a rail body made of hard rubber-plastic foam, and a through hole penetrating along a length direction of the rail body is provided on a side of the rail body, and the through hole is configured to accommodate a first webbing.

2. The roof rail assembly according to claim 1, wherein the hard rubber-plastic foam is EVA material.

3. The roof rail assembly according to claim 1, wherein a bottom of the rail body is planar, and the bottom of the rail body is provided with first anti-skid pattern.

4. The roof rail assembly according to claim 1, wherein at least one first groove is provided on the bottom of the rail body, and the first groove communicates with the through hole.

5. The roof rail assembly according to claim 1, wherein top of the rail body is provided with at least two fasteners along its length direction, and the fasteners are configured to fix a second webbing.

6. The roof rail assembly according to claim 5, wherein the top of the rail body is provided with at least one engaging groove, and the engaging groove is located between the two fasteners.

7. The roof rail assembly according to claim 5, wherein the top of the rail body is provided with a second groove, and the fasteners are arranged in the second groove.

8. The roof rail assembly according to claim 7, wherein the fastener comprises a fastener body, a first stopper fixed at a lower end of the fastener body, and a second stopper matching the first stopper, a first mounting hole for accommodating the first stopper is provided at a lower end of the second groove, and a second mounting hole for accommodating the second stopper is provided at an upper end of the through hole, the first mounting hole and the second mounting hole communicate in the same vertical direction, the first stopper and the second stopper move toward each other along the first mounting hole and the second mounting hole respectively until the first stopper and the second stopper are locked to each other.

9. The roof rail assembly according to claim 1, wherein a top of the rail body is planar, and the top of the rail body is provided with a second anti-skid pattern.

10. A roof rail, comprising at least two roof rail assemblies according to claim 1, and any two of the roof rail assemblies are sequentially combined along their lengths, the first webbing passes through the through holes of the two roof rail assemblies in sequence, and a first and last ends of the first webbing are fixed in a first buckle.
